(19) United States
(12) Patent Application Publication
(10) Pub. No.: US 2016/0192107 A1
(43) Pub. Date: Jun. 30, 2016

(54) System And Method To Selectively Manage Add-On Data, Application, Software, Hardware On A Handheld Device Over The Air

(71) Applicant: Tech Mahindra Ltd., Pune (IN)

(72) Inventor: Gaurav Mittal, Delhi (IN)

(21) Appl. No.: 14/945,876

(22) Filed: Nov. 19, 2015

(30) Foreign Application Priority Data
Dec. 26, 2014 (IN) 4160/MUM/2014

(51) Int. Cl. H04W 4/00; H04L 29/08; H04L 5/00; H04B 1/3827

(52) U.S. Cl. CPC H04W 4/001; H04B 1/3833; H04L 67/34; H04L 5/0055

(57) ABSTRACT

Disclosed is a method and system for selectively managing application, software, hardware and data on a device over the air using Open Mobile Alliance Device Management (OMA DM) specification thereon. The system and method facilitates seamless management of the applications using OMA DM specifications. Further, system and method allows managing these applications at individual level independent of any dependencies. The system and method allows client to register or de-register applications on OMA DM tree which can be further managed at individual application level by enterprise.

### FIELD OF THE INVENTION

This invention relates to over-the-air management of device data/application, and more particularly, to a system and method for selectively managing the add-on data, application, software, third party hardware installed-on, attached-to the device beyond the factory default software or via OMA DM.

### DEFINITIONS OF TERMS USED IN THE SPECIFICATION

The expression ‘Device’ used hereinafter in the specification refers to the any handheld or mobile device provided by an enterprise or any personal device.

The expression ‘OMA DM’ used hereinafter in the specification refers to the Open Mobile Alliance Device Management specification.

The expression ‘MDM’ used hereinafter in the specification refers to the Mobile Device Management system.

The expression ‘BYOD’ used hereinafter in the specification refers to the Bring Your Own Device.

The expression ‘DM Tree’ used hereinafter in the specification refers to the Device Management Tree structure.

The expression ‘IOT’ used hereinafter in the specification refers to the Internet of Things devices.

### BACKGROUND OF THE INVENTION

With the development of mobile devices, the trend of its use in various industries got emerged. Various enterprises started providing mobile devices to their employees to have an efficient working process. Later, the concept of BYOD (Bring Your Own Device) was developed which allowed employees to use their own devices for personal as well as enterprise related work. With the increased use of mobile devices, there emerged a need of mobile device management system (MDM) through which enterprise can remotely manage the devices provided to their employees. Open Mobile Alliance (OMA) a standard body was formed which defined open standard or protocol for device management using which the mobile devices can be managed over-the-air and they are mainly intended to support provisioning, device configuration, software upgrades and fault management.

Currently OMA DM protocol allows to manage over-the-air the device software burned in the device at the factory or software components installed on the device, however it does not define a method to selectively manage add-on data, application, software, hardware installed on the device beyond the factory default list or via OMA DM. Importantly, there is also no provision in the OMA DM specifications to manage the gadgets (wearable or otherwise) having an independent hardware, such as health monitor (such a device may monitor the health of a user and sends the information to the hospital cloud through a smart device or independently) or in another instance monitor car-reader which monitors the health of the car and automatically transmits the car service parameters to the user designated car service station through a smart device or independently. A person skilled in art is able to appreciate that such gadgets mostly come with their own proprietary software which is installed as add-on software on device via interne, Bluetooth, etc. and seldom come pre-bundled with the device or are installed on the device using OMA DM.

The solution understood today is more about the separation in context of enterprise or personal application data (block level) i.e. removing all data associated with enterprise block without touching personal data which is known as container approach or selective wipe. No reference to selective lock and wipe at the “individual application level” which is one step deeper into the personal or enterprise block is provided by the currently available solutions.

Further “container approach” available in the market today is heavyweight mechanism where all the enterprise related application, data is placed behind this container thus separating it from personal data. Container approach is also a drain of device resources such as 1) battery life since the agent is always running; 2) creates unnecessary data traffic (operationally expensive) since the agent is either always connected or keeps attempting to connect to the back end server and 3) any new application which enterprise wants to deploy for its employee will need to be first customized (wrapped) to work in proprietary MDM container which is significant rework on application and for application developers (very inflexible). Also, since container approach are all proprietary and builds a pipe between client and server i.e. binding the firm to invest in both client and server from the same vendor (only 1 side will not work standalone) hence making it more capital extensive for the customers compared to standardized OMA DM approach.

Lastly, there will be over 10 billion mobile-connected devices by 2018, including machine-to-machine (M2M) modules exceeding the world's population at that time (7.6 billion). There is clear need that such M2M modules can be configured over-the-air without the need for user to physically walk in a store/service center to update the settings/configuration of these mobile-connected devices as well as there exist a need to provide a method and system which addresses the above challenges & lacuna effectively in current mobile device management system through suitable enhancements.

### ASPECTS OF THE INVENTION

Some of the optional aspects of the present disclosure aimed to address one or more problems of the prior art or to at least provide a useful alternative are described herein below:

An optional aspect of the present invention is to provide an improved and efficient method for seamlessly managing the devices over the air using OMA DM specification.

Another object of the present invention is to provide a method to manage the applications installed on devices at individual level independent of any other dependencies.

Further optional aspect of the present invention is to provide a mechanism for managing the devices which has low memory footprint.

Yet another optional aspect of the present invention is to provide extremely light weight and low cost mechanism for managing applications.

Other aspects and advantages of the present disclosure will be more apparent from the following description when read in conjunction with the accompanying figures, which are not intended to limit the scope of the present disclosure.

### SUMMARY OF THE INVENTION

Accordingly, in one aspect, the present invention provides a method for selectively managing application, software, hardware and data on a device over the air using Open Mobile Alliance Device Management (OMA DM) specification thereon. The method includes registering the application with a modified OMA DM client by sending request to create a new management object (“MO”) corresponding to the application by the OMA DM client to the DM tree. Further, the method includes processing the information to create a new management object “MO” for the registered application and get it added with DM tree. Furthermore, the method includes initiating an OMA DM session by the OMA DM client and passing updated tree information to the OMA DM Server. Finally, the method includes enabling interaction between OMA DM server and the registered application by opening an interface towards the registered application(s), wherein the application once attached to the DM Tree is able to utilize all the functionalities provided by OMA DM server with or without any user intervention.

In another aspect, the present invention provides a system for selectively managing application, software, hardware and data on a device over the air using Open Mobile Alliance Device Management (OMA DM) specification thereon. The system includes a gadget having an interface for communication, and a communication device having Open Mobile Alliance Device Management (OMA DM) capability and Open Mobile Alliance Device Management (OMA DM) client. The communication device is connected to the gadget by any one of wired or wireless means, wherein the gadget communicates with communication device through the interface. The system further includes an Open Mobile Alliance Device Management (OMA DM) client, wherein the gadget is being capable of registering with the OMA DM client thereby providing the device applications, software, hardware and/or data to an OMA DM server in the form of Management Object (MO) or a node of the DM tree with plurality of Management Objects.

### BRIEF DESCRIPTION OF DRAWINGS

A system and method for achieving the above objectives will be described with the help of accompanying drawings, in which:

FIG. 1 represents a system for selectively managing add-on data, application, software, hardware on a handheld device over the air, in accordance with the present invention;

FIG. 2 represents a message sequence diagram for application registration in accordance with the present invention; and

FIG. 3 represents a message sequence diagram for application de-registration in accordance with the present invention.

FIGS. 4, 5 and 6 shows three different scenarios prior to the registration of the application.

### DETAIL DESCRIPTION OF THE INVENTION:

A preferred embodiment will now be described in detail with reference to the accompanying drawings. The preferred embodiment does not limit the scope and ambit of the invention. The description provided is purely by way of example and illustration.

The present invention relates to an improved and efficient method of device management over the air. The invention facilitates seamless management of the applications using OMA DM specifications. Further, it allows managing these applications at individual level in dependent of any dependencies. It allows client to register or de-register applications on OMA DM tree which can be further managed at individual application level by enterprise.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The method of the present invention provides a light weight and low cost mechanism for handling the enterprise and more specifically personal applications.

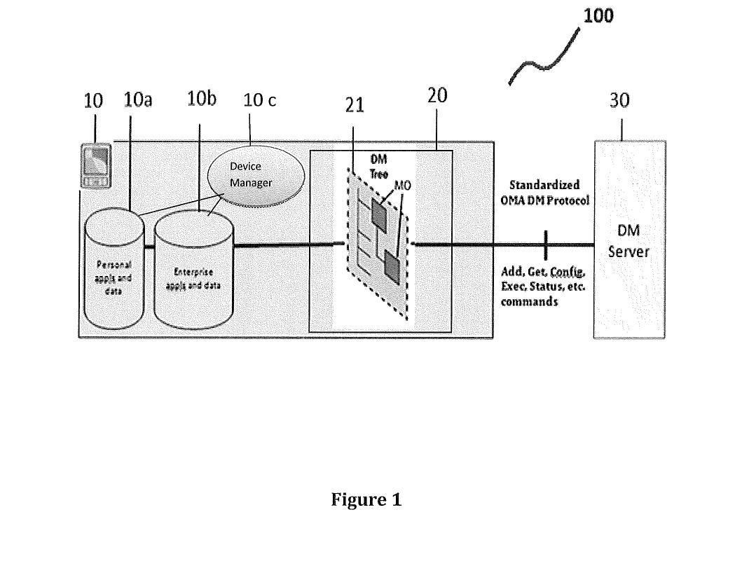

The system and method of the present invention will be described herein below with reference to FIG. 1.

Referring now to FIGS. 1 to 3, there is shown a system (100) for selectively managing application, software, hardware and data on a device (10) over the air using Open Mobile Alliance Device Management (OMA DM) specification, in accordance with one aspect of the present invention. The system (100) is capable of working in conjunction with a gadget having an interface for communication. In an embodiment, the gadget is any gadget used routinely, for example, a health-o-meter.

The system includes a communication device (10) capable having Open Mobile Alliance Device Management (OMA DM) client (20) thereon. The communication device (10) typically consists of personal (10a) and enterprise (10b) related data and applications. In an embodiment, the communication device is any one Smartphone, laptop or similar devices. The communication device (10) is connected to the gadget (not shown) by any one of wired or wireless means. In an embodiment, the wireless means is Bluetooth. The gadget communicates with communication device (10) through the interface of the gadget. The Device Manager (10c) display and hold a list of all the applications installed or downloaded or running on the device and trigger various services that are required to manage these applications such as permissions to access device services, start at boot, uninstall the application, clear cache memory of the application, access to system tools/background processes, hardware controls like vibrator

Further, the gadget or its applications, software and/or data registers with the Open Mobile Alliance Device Management (OMA DM) client (20) thereby providing its applications, software, hardware and/or data to an OMA DM server (30) via the communication device (10) in the form of Management Object (MO) or a node of the DM tree with plurality of Management Objects (21)

The tree is typically known as “DM Tree” while the building blocks are called as management object (“MO”) (21) providing specific functionality in managing the gadget and its applications, software, data. For example, managing device setting or user data settings such as Proxy address. The MO will be able to update these settings in the gadget. Settings can be for a gadget hardware or for an application, software, data in the gadget.

Management of this management object constitutes management of the communication device (10) which virtualizes the device features and functionalities. Applications running on the communication device (10) can interact with DM Tree (21) and server (30) to receive the updates.

It is important to note that the system (100) can be used for the devices supporting OMA DM specification.

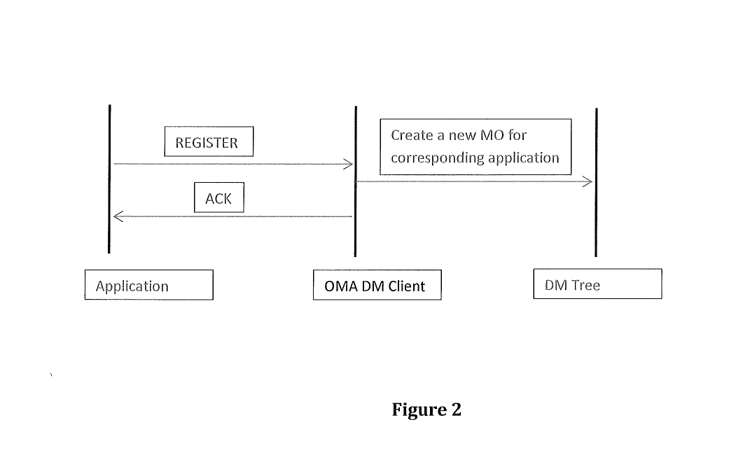

As described in the FIG. 2 in conjunction with FIG. 1, whenever user installs new application on the communication device (10), the application registers itself by sending REGISTER message to the OMA DM client (20) and get an acknowledgement message back once the application gets registered. The registered application gets added with OMA DM tree by creating a node or management object (“MO”) (21). However, the DM specifications do not tell how client should create the Management Object in the DM tree. There are various techniques known for creating the node or “MO” in the DM tree, any of which can be used herein. For example, the OMA DM client (20) informs DM tree (21) in that particular instance by sending an event asking to create MO with default settings.

The way OMA DM client (20) interacts with add-on application is simply via opening interface towards the application(s) to register/de-register themselves. These interfaces are specified by the OMA DM Client Framework API.

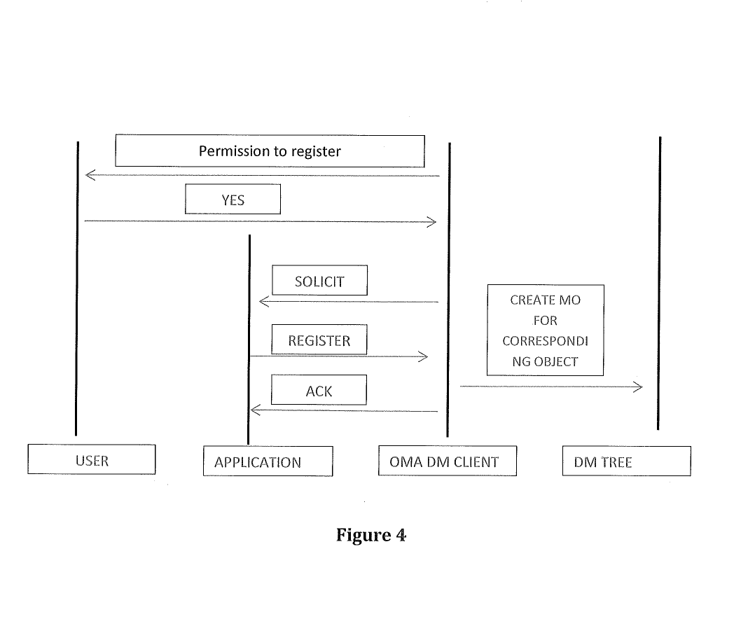

FIG. 4 depicts a scenario where application is installed but does not take steps to register itself, then OMA DM client (20) initiates a pop up message to the user and asking the user's permission whether the user would like to register the application. If the user says yes, then OMA DM client (20) initiates SOLICIT message to application. Upon receiving SOLICIT, the application takes necessary steps to register and normal process goes on.

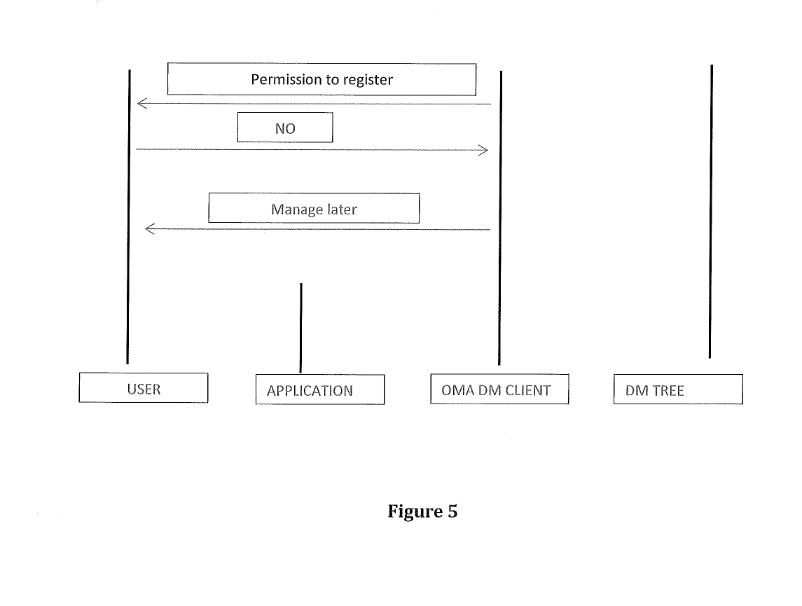

FIG. 5 depicts a scenario where the user denies the permission sought by the OMA DM Client (20) to register an Application. In this case to a pop-up message sent by OMA DM client is returned with NO response by the User and upon receipt of this response, the OMA DM Client sends Manage later message to the User using the device settings.

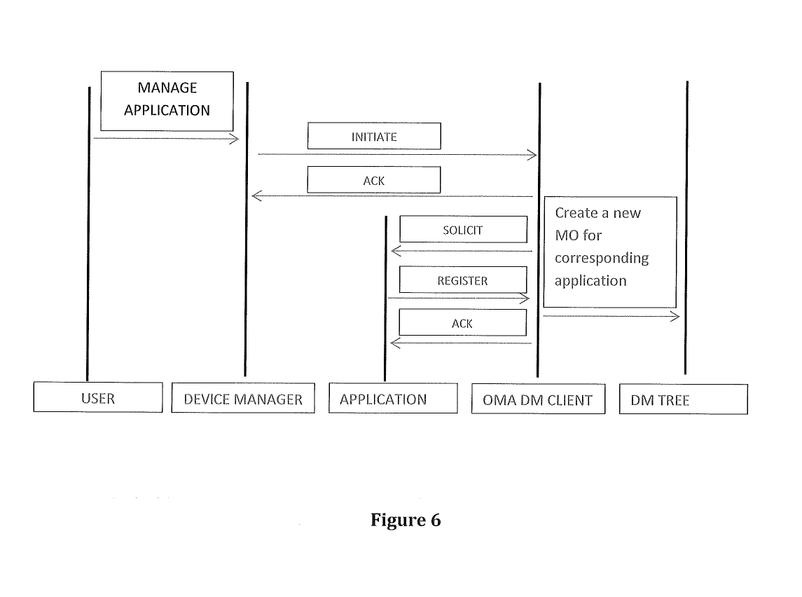

FIG. 6 depicts a scenario where at a given point of time, the user decides to manage a previously installed application then the User goes to Device Manager or any such application which lists all the application installed on the device and clicks on MANAGE icon wishing to manage a listed application using OMA DM. Device Manager sends INITIATE message to the OMA DM client OMA DM client sends ACK message to Device manager. OMA DM client then initiates SOLICIT message to application. Upon receiving the SOLICIT message, application will take necessary steps to register (sends REGISTER message). Then normal process goes on. The application once attached to the DM Tree (21) is then able to utilize all the rich functionality provided by OMA DM server (30) standard available and can be managed at an individual level independent of any dependencies to other block of applications, data, software or hardware and also enables OMA DM Server (30) to carry out all the regular functions such as configure, update, install and the like.

Thus for each application installed on the device corresponding node or “MO” is created on OMA DM tree (21) which is further managed by the OMA DM Server (30) without any user intervention.

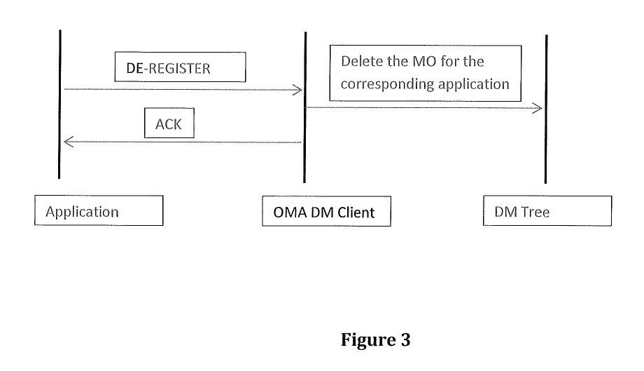

The same way application can be de-registered from OMA DM client by sending a DE-REGISTER message and client gets acknowledgement back for the same as shown in the FIG. 3.

In another aspect, the present invention provides a method for selectively managing application, software, hardware and data on a device over the air using Open Mobile Alliance Device Management (OMA DM) specification thereon. The method includes registering the application with a modified OMA DM client by sending request to create a new management object (“MO”) corresponding to the application by the OMA DM client to the DM tree. In an embodiment, the application is registered by sending a REGISTER message by the application to the OMA DM client. The node or “MO” in the DM tree is created by using a method of sending create message with default settings.

The method further includes processing the information to create a new management object “MO” for the registered application and get it added with DM tree. The registered applications running on the device interacts with the DM tree and OMA DM client to receive the updates therefrom.

The method furthermore includes initiating by the client an OMA DM session and passing the updated tree information to an OMA DM Server.

The method also includes enabling interaction between OMA DM client and the registered application by opening an interface towards the registered application(s). In an embodiment, the interface is a new application program interface (API) to facilitate the registration of the application.

The application once attached to the DM Tree is able to utilize all the functionalities provided by OMA DM server with or without any user intervention.

The application can be de- the OMA DM tree by sending a DE-REGISTER message from OMA DM Client to DM tree and removing the MO.

Specifically, the communication devices not supporting the OMA DM specifications will connect to the OMA DM client using the devices which support the OMA DM specifications.

The present invention utilizes OMA DM specification which enables it to have reduced memory footprint and light weight as against container approach and the session between the user and server is established only on demand thereby reducing the data traffic thus saving the ample amount of battery life. The method stated above can be extended to enterprise application and data.

The present invention herein explained with the help of examples or use cases however; these examples are only for illustrative purpose for providing better understanding of the present invention and shall limit the scope of the present invention. The person skilled in the art would appreciate that the present invention has wider applicability and can be used in various business scenarios.

### EXAMPLE 1

The system and the method depicted above can be extended to various personal applications such as personal health applications. The typical event flow of the management of health application according to present invention is as follows: User installs a new personal health application on his/her device which is associated with the health-o-meter gadget user has just purchased. The application sends every day the heart rate or pulse oxy readings to his/her doctor or cloud associated with Scripps hospital. The person skilled in the art would appreciate that the health-o-meter gadget can easily be replaced by any IOT or a wearable device.

Upon installation of the software the application announces and registers itself with the OMA DM client.

The registration information is processed internally by the OMA DM client and accordingly creates a new management object (“MO”) for the given health application in DM tree structure.

Hospital has a tie with local operator and utilizes operator OMA DM Server to then send a “Get” command to know the latest list of management objects and sends the “Config” command to appropriately set the user specific settings for her health application.

At a later time, due to any reasons if user has to move to different city and hence Scripps need to modify the name of doctor to which heart reading should go and at the same time, due to user medical condition, wants to get the reading twice a day instead of once earlier.

A simple command is sent to the health application management object and selectively the settings associated with the health application are updated over the air. A person skilled in art will be able to appreciate that the said operation is performed seamlessly over the air without user ever having the need to walk to a service station thus bringing peace of mind saving him significant effort and some costs to find, drive to the nearest service station. Therefore the present invention provides the method to manage the personal application for time, geography specific etc. These settings can be managed remotely through OMA DM.

This allows reutilizing the OMA DM protocol which is standardized, widely deployed, very light-weight and also facilitating the communication between OMA DM client and OMA DM Server. Invention then builds on top of DM protocol such that OMA DM client is able to interact with personal (and IOT, Wearable) applications such as personal health applications and manage them over the air.

### EXAMPLE 2

Enterprise 1 having MDM of company X got bought by Enterprise 2 which has MDM of Company Y. Enterprise 1 has over ten thousand employees having devices with 50 applications. Steps involved in updating the devices according to the present invention if the similar situation would have occurred in OMA DM infrastructure includes:

Since all the 50 applications are placed in the DM tree in the device there is no need for application re-writing or application re-installation.

An OMA DM “Config” command is sent to each device which carries the updated DM Server address.

In a single data session, 1 xml file format carrying all 50 tree nodes is sent to device and switch to new DM server is complete.

As against the other available approaches there is no need to re-write each and every application there by reducing significant rework, cost and time for enterprise Example 3:

Health-o-meter which is non OMA device. This device connects to a smartphone (Or a Laptop) which is OMA DM capable using Bluetooth technology (or using data cable). The health-o-meter device manufacturer by itself will provide an interface to interact with the smartphone or laptop using underlying communication technologies described above. Now when this health device comes to interact with smartphone for the first time the smartphone will treat it the same way as new application is downloaded and will for example show it in Device manager. In a way health device announces itself to the smartphone device just like a new application announces itself. At this instance the health device has option to register itself with the OMA DM client just like any other device application using the same interface.

Similarly, if the address of the cloud to which the data need to be send changes due to any reason, the settings can be changed accordingly so that the data can be send from one cloud to another. This manageability is done through OMA DM. Therefore, even the data to be sent to the cloud remains standard its destination address can be changed through OMA DM. Similarly, even the library of the application is common for all the data specific to the end user will be different for different users and this user specific data can be managed by the present invention.

In another embodiment of the present invention applications can be managed for time, geography specific etc. settings can be managed remotely through OMA DM.

### ADVANTAGES OF THE INVENTION

The technical advancements of the system envisaged by the present invention include the realization of:

A device management method that facilitates an efficient way of seamlessly managing the applications installed on the devices at individual level independent of any dependencies using OMA DM specifications;

A method that help to manage the applications over the air thereby reducing the cost and efforts of users by eliminating the need to walk to a service station;

A method that facilitate individual applications to register or de-register on OMA DM tree there by allowing it to utilize all rich functionality provided by OMA DM standard;

A mechanism that is extremely light weight and low cost for managing the applications;

A method that is technically superior for managing enterprise applications and can be extended to variety of personal applications (IOT, wearable etc.);

A method that eliminates the need of re-writing or re-installing the application;

A mechanism to manage the device applications that provides higher battery life and reduced data traffic; and

A method to manage the devices with low memory footprint.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results.

The numerical values mentioned for the various physical parameters, dimensions or quantities are only approximations and it is envisaged that the values higher/lower than the numerical values assigned to the parameters, dimensions or quantities fall within the scope of the invention, unless there is a statement in the specification specific to the contrary.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for selectively managing application, software, hardware and data on a device over the air using Open Mobile Alliance Device Management (OMA DM) specification thereon, the method comprising:
registering the application with a modified OMA DM client by sending request to create a new management object (“MO”) corresponding to the application by the OMA DM client to the DM tree;
processing the information to create a new management object “MO” for the registered application and get it added with DM tree;
initiating by the client OMA DM session and passing updated tree information to the OMA DM Server; and
enabling interaction between OMA DM server and the registered application by opening an interface towards the registered application(s), wherein the application once attached to the DM Tree is able to utilize all the functionalities provided by OMA DM server with or without any user intervention.

2. The method as claimed in claim 1, wherein the application is registered by sending a REGISTER message by the application to the OMA DM client.

3. The method as claimed in claim 1, wherein application is installed but does not take steps to register itself, then the application is registered by OMA DM client initiating a SOLICIT message to the application subject to the user acceptance and upon receiving SOLICIT, the application registers itself by sending a REGISTER message to the OMA DM client.

4. The method as claimed in claim 1, wherein the user manages previously installed applications by sending MANAGE APPLICATION message to the device Manager and the device manager further sends INITIATE message to the OMA DM Client and gets an ACK from OMA DM Client followed by an SOLICIT message from the OMA DM Client to the application to complete the registration of application.

5. The method as claimed in claim 1, wherein the modified OMA DM client comprises method of opening a new application program interface (API) to facilitate the registration of the application.

6. The method as claimed in claim 1, wherein the node or “MO” in the DM tree is created by using a method of sending create message with default settings.

7. The method as claimed in claim 1, wherein selective management of the application comprises a method of application de-registration, wherein the user de-registers the application from the OMA DM tree by sending a DE-REGISTER message from OMA DM Client to DM tree and removing the MO.

8. The method as claimed in claim 1, wherein the applications running on the device interact with the DM tree and server to receive the updates therefrom

9. The method as claimed in claim 1, wherein the devices not supporting OMA DM specifications will connect to the server using the devices which support the OMA DM specifications.

10. A system for selectively managing application, software, hardware and data on a device over the air using Open Mobile Alliance Device Management (OMA DM) specification thereon, the system comprising:
a gadget having an interface for communication;
a communication device capable having Open Mobile Alliance Device Management (OMA DM) thereon, the communication device connected to the gadget by any one of wired or wireless means, wherein the gadget communicates with communication device through the interface: and
Open Mobile Alliance Device Management (OMA DM) client, wherein the gadget is being capable of registering with the OMA DM client thereby providing the device applications, software, hardware and/or data to an OMA DM server in the form of Management Object (MO) or a node of the DM tree with plurality of Management Objects; and
a device Manager capable of storing and managing a list of applications to be managed by the device.

11. The system as claimed in claim 10, wherein the node or “MO” in the DM tree is created by using a method of sending create message with default settings.
